(19) United States
(12) Patent Application Publication
(10) Pub. No.: US 2013/0201503 A1
(43) Pub. Date: Aug. 8, 2013

(54) FILTERING OF PRINTERS FOR DRIVERLESS PRINTING

(71) Applicants: Howard A. Miller, Saratoga, CA (US); Michael R. Sweet, Morgan Hill, CA (US); Todd W. Ritland, San Francisco, CA (US)

(72) Inventors: Howard A. Miller, Saratoga, CA (US); Michael R. Sweet, Morgan Hill, CA (US); Todd W. Ritland, San Francisco, CA (US)

(73) Assignee: APPLE INC., Cupertino, CA (US)

(21) Appl. No.: 13/365,463

(22) Filed: Feb. 3, 2012

(51) Int. Cl. G06F 3/12

(52) U.S. Cl. 358/1.13

(57) ABSTRACT

The disclosed embodiments provide a system that facilitates the execution of a print job. During operation, the system identifies a set of printers providing a driverless-printing service in proximity to a portable electronic device associated with the print job. Next, for each printer from the set of printers, the system attempts to obtain a protocol key and a set of supported capabilities associated with the protocol key from the printer. If the protocol key and the set of supported capabilities exist for the printer, the system determines an eligibility of the printer for the print job based on the protocol key and the set of supported capabilities. If the printer is eligible for the print job, the system provides the printer to a user of the portable electronic device to enable subsequent selection of the printer for the print job.

### RELATED APPLICATION

The subject matter of this application is related to the subject matter in a co-pending non-provisional application by inventors Michael R. Sweet and Howard Miller and filed 14 Sep. 2010, entitled “Framework that Supports Driverless Printing,” having Ser. No. 12/882,116 (Attorney Docket No. APL-P9004US1).

### BACKGROUND

1. Field

The disclosed embodiments relate to printers for computer systems. More specifically, the disclosed embodiments relate to techniques for filtering printers for driverless printing based on a published driverless-printing service, a protocol key, and/or a set of supported capabilities associated with the printers.

2. Related Art

Printers are often a problem for computer users. When a computer user initially installs a printer, the cabling and power cords are typically relatively straightforward to hook up. However, the user also has to install a printer-specific driver, which involves loading the driver from a disk and/or navigating to a website and downloading the driver. Even if the printer driver is already loaded into the computer system, the user may have to load and install an update for the driver from the printer manufacturer's website. Such installation operations are time-consuming and commonly require the user to find and enter a long software-license key.

Printers pose an even bigger problem for users of portable electronic devices, such as laptop computers, tablet computers, portable media players, or smartphones. Such portable electronic devices are seldom configured with the requisite printer driver software. In addition, installing the appropriate printer driver can be bothersome, especially if the user of the portable electronic device only intends to use the nearby printer once or twice. Portable electronic devices may also have limited storage space, which makes it impractical for them to store a large number of printer drivers.

Hence, what is needed is a system that facilitates printing from a portable electronic device to a nearby printer without the above-described problems.

### SUMMARY

The disclosed embodiments provide a system that facilitates the execution of a print job. During operation, the system identifies a set of printers providing a driverless-printing service in proximity to a portable electronic device associated with the print job. Next, for each printer from the set of printers, the system attempts to obtain a protocol key and a set of supported capabilities associated with the protocol key from the printer. If the protocol key and the set of supported capabilities exist for the printer, the system determines an eligibility of the printer for the print job based on the protocol key and the set of supported capabilities. If the printer is eligible for the print job, the system provides the printer to a user of the portable electronic device to enable subsequent selection of the printer for the print job.

In some embodiments, if the printer is not eligible for the print job, the system disables the subsequent selection of the printer for the print job.

In some embodiments, the system uses a discovery protocol to identify the set of printers providing the driverless-printing service and obtain the protocol key and the set of supported capabilities from the printer.

In some embodiments, determining the eligibility of the printer for the print job based on the protocol key and the set of supported capabilities involves comparing the supported capabilities with a set of minimum required capabilities for a protocol associated with the protocol key, and identifying the printer as eligible for the print job if the supported capabilities meet the minimum required capabilities.

In some embodiments, the protocol is at least one of a raster format protocol and a page description language protocol.

In some embodiments, providing the printer to the user of the portable electronic device involves displaying the printer and other eligible printers from the set of printers to the user.

In some embodiments, the set of supported capabilities comprises at least one of a file size and an image dimension.

### BRIEF DESCRIPTION OF THE FIGURES

FIG. 1 shows a printing system in accordance with the disclosed embodiments.

FIG. 2 shows a system for facilitating the execution of a print job in accordance with the disclosed embodiments.

FIG. 3 shows a flowchart illustrating the process of facilitating the execution of a print job in accordance with the disclosed embodiments.

FIG. 4 shows a flowchart illustrating the process of facilitating the use of a printer in performing a print job in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

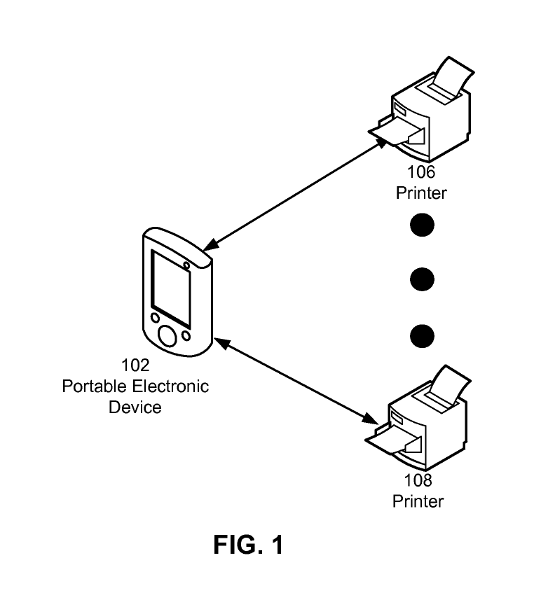

The disclosed embodiments facilitate the performing of print jobs from portable electronic devices. As shown in FIG. 1, a portable electronic device 102 includes functionality to communicate with a set of printers 106-108. Portable electronic device 102 may correspond to a mobile phone, laptop computer, tablet computer, personal digital assistant (PDA), portable media player, and/or other type of battery-powered electronic device. Printers 106-108 may correspond to network printers that are capable of wired and/or wireless communications. Alternatively, one or more printers may connect to a print server as local peripherals using one or more printer cables and/or one or more ports (e.g., parallel ports, serial ports, Universal Serial Bus (USB) ports).

Portable electronic device 102 may interact with printers 106-108 through one or more networks. Such networks may include any type of communication channel capable of coupling together network nodes. For example, the network(s) may include a wireless network connection, such as a Bluetooth (Bluetooth™ is a registered trademark of Bluetooth SIG, Inc.) network connection; a cellular networking connection (e.g., a 3G/4G network or an Edge network); a networking connection based on the standards described in Institute for Electrical and Electronic Engineers (IEEE) 802.11; a wireless personal-area networking (PAN) connection, such as a network connection based on the standards described in IEEE 802.15; or any peer-to-peer (wireless or wired) networking technology.

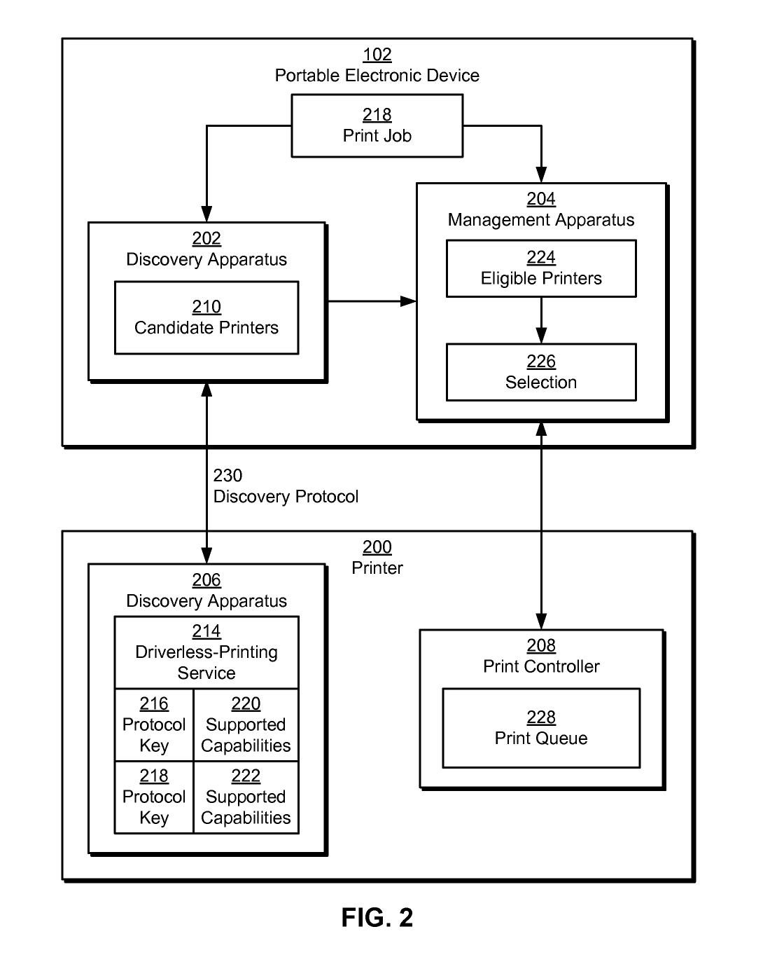

In one or more embodiments, the printing system of FIG. 1 includes functionality to perform “driverless printing,” in which a user of portable electronic device 102 may print to a nearby printer (e.g., printers 106-108) without installing and/or updating associated printer driver software. As shown in FIG. 2, a discovery apparatus 202 in portable electronic device 102 may discover (e.g., detect) a nearby printer 200 for use in performing a print job 218 using a discovery protocol 230 such as Bonjour (Bonjour™ is a registered trademark of Apple Inc.). To enable detection of printer 200 by portable electronic device 102, a corresponding discovery apparatus 206 on printer 200 may advertise a driverless-printing service 214 on discovery protocol 230. For example, discovery apparatus 206 may advertise driverless-printing service 214 on Bonjour by publishing a specific service type and subtype.

Once printer 200 is selected for performing print job 218 (e.g., by a user of portable electronic device 102), a management apparatus 204 on portable electronic device 102 may obtain print job 218 from an application on portable electronic device 102 and transmit print job 218 to printer 200 over a network connection with printer 200. A print controller 208 in printer 200 may then place print job 218 into a print queue 228 and execute print job 218 after print jobs preceding print job 218 in print queue 228 have been completed and/or cancelled. Driverless printing for portable electronic devices is discussed in further detail in a co-pending non-provisional application by inventors Michael R. Sweet and Howard Miller and filed 14 Sep. 2010, entitled “Framework that Supports Driverless Printing,” having Ser. No. 12/882,116 (Attorney Docket No. APL-P9004US1), which is incorporated herein by reference.

In one or more embodiments, portable electronic device 102 includes functionality to assess a printer's (e.g., printer 200) compliance with a specification for driverless-printing service 214 by analyzing information provided by the printer. If the information indicates that the printer fully supports driverless-printing service 214, portable electronic device 102 may enable subsequent use of the printer in performing print job 218 and/or other print jobs on portable electronic device 102. Conversely, if the information indicates that the printer does not fully support driverless-printing service 214, portable electronic device 102 may disable the use of the printer in performing the print jobs.

More specifically, portable electronic device 102 may identify a set of candidate printers 210 providing driverless-printing service 214 in proximity to portable electronic device 102. For example, portable electronic device 102 may populate candidate printers 210 with printer 200 and/or other printers that advertise driverless-printing service 214 on the same link-local network as portable electronic device 102.

Next, for printer 200 and other printers in the set of candidate printers 210, discovery apparatus 202 may attempt to obtain one or more protocol keys 216-218 and a set of supported capabilities 220-222 associated with each protocol key. For example, discovery apparatus 202 may query discovery apparatus 206 for one or more Bonjour TXT records associated with driverless-printing service 214 and search the TXT record(s) for specific protocol keys 216-218 and/or supported capabilities 220-222. Printers (e.g., printer 200) that are configured to comply with the specification for driverless-printing service 214 may provide valid protocol keys 216-218 and supported capabilities 220-222, while printers that are not configured correctly for compliance with the specification may omit required protocol keys 216-218 and/or supported capabilities 220-222 and/or provide invalid protocol keys 216-218 and/or supported capabilities 220-222.

In one or more embodiments, protocol keys 216-218 and supported capabilities 220-222 correspond to key-value pairs that supply information related to protocols associated with driverless-printing service 214. Protocol keys 216-218 may represent printing protocols supported by printer 200, and supported capabilities 220-222 may correspond to the printer's capabilities with respect to the printing protocols. For example, each protocol key 216-218 may represent a raster format protocol, Portable Document Format (PDF) protocol, and/or other page description language protocol supported by printer 200. As a result, each set of supported capabilities 220-222 may include a file size and/or an image dimension for the protocol represented by the corresponding protocol key.

If protocol keys 216-218 and supported capabilities 220-222 exist for printer 200, management apparatus 204 may determine an eligibility of printer 200 for print job 218 based on protocol keys 216-218 and supported capabilities 220-222. In particular, management apparatus 204 may compare supported capabilities 220-222 with a set of minimum required capabilities for the protocols associated with protocol keys 216-218. The minimum required capabilities may be defined in the specification for driverless-printing service 214. For example, the minimum required capabilities may include a minimum resolution, file size, print quality, image dimension, set of color spaces, and/or other protocol-based capabilities to be provided by a printer that fully supports driverless-printing service 214.

If supported capabilities 220-222 meet the minimum required capabilities, management apparatus 204 may identify printer 200 as eligible for print job 218 and include printer 200 in a set of eligible printers 224 for print job 218. Management apparatus 204 may then provide eligible printers 224 to a user of portable electronic device 102 to enable the subsequent selection 226 of printer 200 or another printer in eligible printers 224 for print job 218. For example, management apparatus 204 may use a graphical-user interface (GUI) to display printer 200 and other eligible printers 224 to the user and obtain selection 226 from the user. After selection 226 is made, management apparatus 204 may transmit print job 218 to the printer corresponding to selection 226 for execution of print job 218 by the printer.

On the other hand, if supported capabilities 220-222 do not meet the minimum required capabilities, management apparatus 204 may disable the subsequent selection of printer 200 for print job 218. Continuing with the above example, management apparatus 204 may omit printer 200 from the list of eligible printers 224 displayed to the user if supported capabilities 220-222 indicate that printer 200 does not provide all capabilities required to fully support driverless-printing service 214. In other words, portable electronic device 102 may perform filtering of printers for driverless printing on portable electronic device 102 based on each printer's stated ability to fully support driverless printing.

For example, support for driverless-printing service 214 may be indicated by a raster-supported key specifying a set of capabilities that enables a client (e.g., portable electronic device 102) to generate rasterized print data for a print job (e.g., print job 218) without having to maintain printer-specific software or printer-specific configuration information for printer 200. Raster-supported keys for printers are described in further detail in the above-referenced application. The presence of the raster-supported key and corresponding capabilities (e.g., in protocol keys 216-218 and supported capabilities 220-222) in information obtained from a printer (e.g., printer 200) through discovery protocol 230 may indicate that the printer is configured to support driverless-printing service 214. On the other hand, the absence of the raster-supported key and/or one or more corresponding capabilities in the information may indicate that the printer is not configured to support driverless-printing service 214. To mitigate issues with printing using driverless-printing service 214, only printers that are configured to support driverless-printing service 214 (e.g., printers that provide the raster-supported key and corresponding capabilities) are eligible to be selected for performing print jobs using driverless-printing service 214.

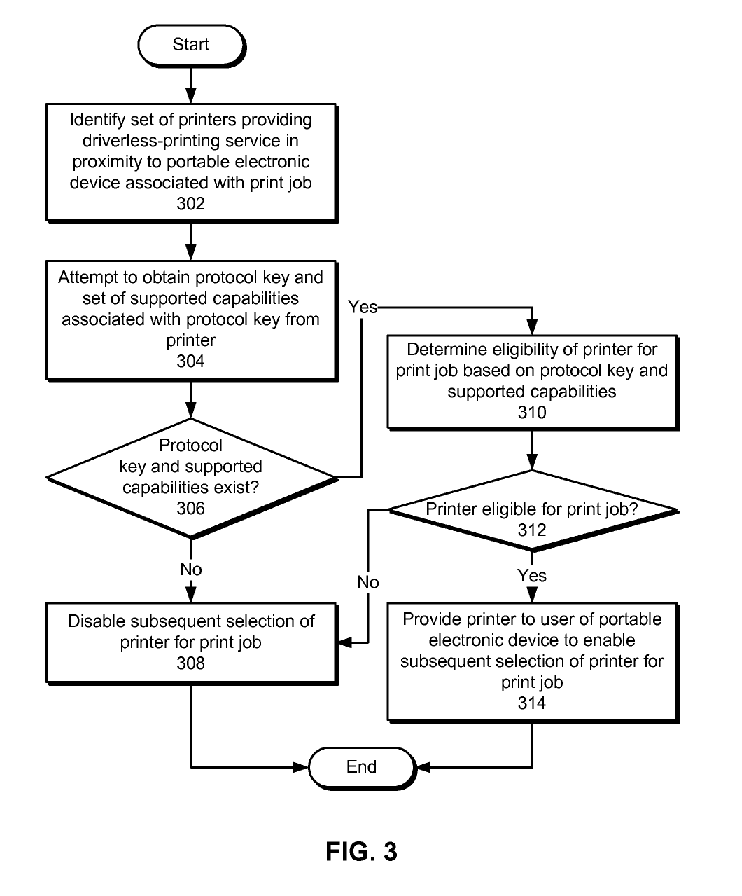

FIG. 3 shows a flowchart illustrating the process of facilitating the execution of a print job in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the technique.

Initially, a set of printers providing a driverless-printing service in proximity to a portable electronic device associated with the print job is identified (operation 302). The printers may be identified using a discovery protocol such as Bonjour. For example, Bonjour may be used to detect a printer as providing the driverless-printing service in proximity to the portable electronic device if the printer is on the same link-local network as the portable electronic device and advertises a specific service type and subtype.

Next, for each printer from the set of printers, an attempt is made to obtain a protocol key and a set of supported capabilities associated with the protocol key from the printer (operation 304). For example, the printer may be queried for Bonjour TXT records associated with the driverless-printing service, and the TXT records may be examined for a raster-supported protocol key and/or supported capabilities, as well as protocol keys and supported capabilities for one or more page description languages (e.g., PDF) supported by the printer.

Use of the printer in performing the print job may be enabled or disabled based on the existence of the protocol key and supported capabilities (operation 306). If the protocol key and supported capabilities do not exist for the printer, subsequent selection of the printer for the print job is disabled (operation 308) to prevent issues associated with printing using the driverless-printing service. For example, the printer may be omitted from a list of eligible printers for the print job that is displayed to the user through a GUI of the portable electronic device.

If the protocol key and supported capabilities exist for the printer, the printer's eligibility for the print job is determined based on the protocol key and supported capabilities (operation 310). For example, the supported capabilities may be compared with a set of minimum required capabilities for a protocol (e.g., raster format protocol, page description language protocol, etc.) associated with the protocol key (e.g., as defined in a specification for the driverless-printing service). The printer may then be identified as eligible for the print job if the supported capabilities meet the minimum required capabilities and as ineligible if the supported capabilities do not meet the minimum required capabilities.

The eligibility of the printer for the print job (operation 312) may affect the use of the printer in performing the print job. If the printer is not eligible for the print job, the subsequent selection of the printer for the print job is disabled (operation 308), as described above. If the printer is eligible for the print job, the printer is provided to the user of the portable electronic device to enable subsequent selection of the printer for the print job (operation 314). For example, the printer may be included in a list of eligible printers for the print job that is displayed to the user through a GUI of the portable electronic device. If the printer is selected within the list by the user, the print job may be sent to the printer for execution of the print job by the printer. Because all printers in the list are stated to comply with the specification for the driverless-printing service, issues associated with performing the print job using the driverless-printing service may be mitigated.

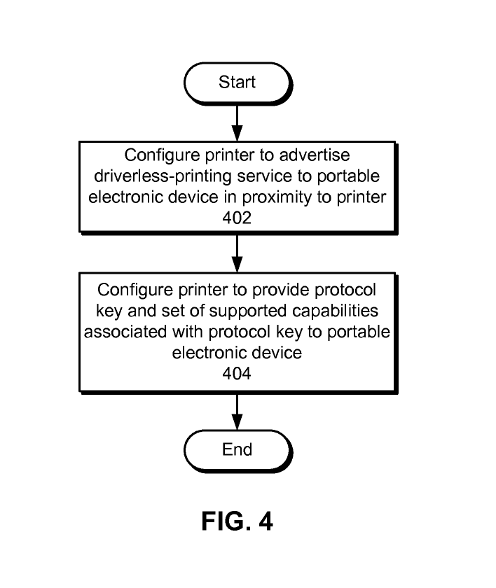

FIG. 4 shows a flowchart illustrating the process of facilitating the use of a printer in performing a print job in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the technique.

Initially, the printer is configured to advertise a driverless-printing service to a portable electronic device in proximity to the printer (operation 402). For example, the printer may use a discovery protocol such as Bonjour to advertise the driverless-printing service to the portable electronic device.

The printer is also configured to provide a protocol key and a set of supported capabilities associated with the protocol key to the portable electronic device (operation 404). The protocol key and/or supported capabilities may also be provided using the discovery protocol. The protocol key may be associated with a raster format protocol and/or a page description language protocol supported by the printer. In addition, the supported capabilities may correspond to the printer's capabilities with respect to the protocol associated with the protocol key. For example, the supported capabilities may include a file size and/or an image dimension capability for the protocol.

The advertised driverless-printing service, protocol key, and/or the set of supported capabilities may enable subsequent use of the printer in performing the print job for the portable electronic device. For example, the driverless-printing service may allow the portable electronic device to identify the printer as a candidate for performing the print job, and the protocol key and/or supported capabilities may be used by the portable electronic device to confirm the printer's eligibility for and/or capability to perform the print job.

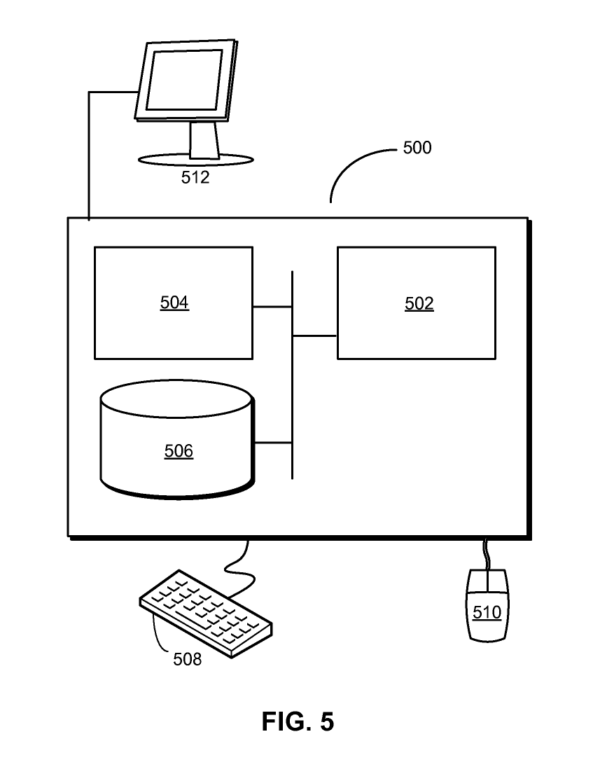

FIG. 5 shows a computer system 500 in accordance with an embodiment. Computer system 500 may correspond to an apparatus that includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for facilitating the execution of a print job. The system may include a discovery apparatus that identifies a set of printers providing a driverless-printing service in proximity to a portable electronic device associated with the print job. Next, for each printer from the set of printers, the discovery apparatus may attempt to obtain a protocol key and a set of supported capabilities associated with the protocol key from the printer. The system may also include a management apparatus that determines an eligibility of the printer for the print job based on the protocol key and the set of supported capabilities if the protocol key and the set of supported capabilities exist for the printer. If the printer is eligible for the print job, the management apparatus may provide the printer to a user of the portable electronic device to enable subsequent selection of the printer for the print job. If the printer is not eligible for the print job, the management apparatus may disable the subsequent selection of the printer for the print job.

In addition, one or more components of computer system 500 may be remotely located and connected to the other components over a network. Portions of the present embodiments (e.g., discovery apparatus, management apparatus, portable electronic device, printer, etc.) may also be located on different nodes of a distributed system that implements the embodiments. For example, the present embodiments may be implemented using a number of portable electronic devices and a number of printers configured to perform printing for the portable electronic devices using a driverless-printing service.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating the execution of a print job, comprising:
identifying a set of printers providing a driverless-printing service in proximity to a portable electronic device associated with the print job; and
for each printer from the set of printers:
attempting to obtain a protocol key and a set of supported capabilities associated with the protocol key from the printer;
if the protocol key and the set of supported capabilities exist for the printer, determining an eligibility of the printer for the print job based on the protocol key and the set of supported capabilities; and
if the printer is eligible for the print job, providing the printer to a user of the portable electronic device to enable subsequent selection of the printer for the print job.

2. The computer-implemented method of claim 1, further comprising:
if the printer is not eligible for the print job, disabling the subsequent selection of the printer for the print job.

3. The computer-implemented method of claim 1, wherein a discovery protocol is used to identify the set of printers providing the driverless-printing service and obtain the protocol key and the set of supported capabilities from the printer.

4. The computer-implemented method of claim 1, wherein determining the eligibility of the printer for the print job based on the protocol key and the set of supported capabilities involves:
comparing the supported capabilities with a set of minimum required capabilities for a protocol associated with the protocol key; and
identifying the printer as eligible for the print job if the supported capabilities meet the minimum required capabilities.

5. The computer-implemented method of claim 4, wherein the protocol is at least one of a raster format protocol and a page description language protocol.

6. The computer-implemented method of claim 1, wherein the set of supported capabilities comprises at least one of a file size and an image dimension.

7. The computer-implemented method of claim 1, wherein providing the printer to the user of the portable electronic device involves:
displaying the printer and other eligible printers from the set of printers to the user.

8. A computer-implemented method for facilitating the use of a printer in performing a print job, comprising:
configuring the printer to advertise a driverless-printing service to a portable electronic device in proximity to the printer; and
configuring the printer to provide a protocol key and a set of supported capabilities associated with the protocol key to the portable electronic device, wherein the protocol key and the set of supported capabilities enable subsequent use of the printer in performing the print job for the portable electronic device.

9. The computer-implemented method of claim 8, wherein the driverless-printing service, the protocol key, and the supported capabilities are provided to the portable electronic device using a discovery protocol.

10. The computer-implemented method of claim 8, wherein the set of supported capabilities comprises at least one of a file size and an image dimension.

11. The computer-implemented method of claim 8, wherein the protocol key is associated with at least one of a raster format protocol and a page description language protocol.

12. A system for facilitating the execution of a print job, comprising:
a discovery apparatus configured to:
identify a set of printers providing a driverless-printing service in proximity to a portable electronic device associated with the print job; and
for each printer from the set of printers, attempt to obtain a protocol key and a set of supported capabilities associated with the protocol key from the printer; and
a management apparatus configured to:
determine an eligibility of the printer for the print job based on the protocol key and the set of supported capabilities if the protocol key and the set of supported capabilities exist for the printer; and
if the printer is eligible for the print job, provide the printer to a user of the portable electronic device to enable subsequent selection of the printer for the print job.

13. The system of claim 12, wherein the management apparatus is further configured to:
disable the subsequent selection of the printer for the print job if the printer is not eligible for the print job.

14. The system of claim 12, wherein a discovery protocol is used to identify the set of printers providing the driverless-printing service and obtain the protocol key and the set of supported capabilities from the printer.

15. The system of claim 12, wherein determining the eligibility of the printer for the print job based on the protocol key and the set of supported capabilities involves:
comparing the supported capabilities with a set of minimum required capabilities for a protocol associated with the protocol key; and
identifying the printer as eligible for the print job if the supported capabilities meet the minimum required capabilities.

16. The system of claim 15, wherein the protocol is at least one of a raster format protocol and a page description language protocol.

17. The system of claim 12, wherein the set of supported capabilities comprises at least one of a file size and an image dimension.

18. The system of claim 12, wherein providing the printer to the user of the portable electronic device involves:
displaying the printer and other eligible printers from the set of printers to the user.

19. A computer-readable storage medium storing instructions that when executed by a computer cause the computer to perform a method for facilitating the execution of a print job, the method comprising:
identifying a set of printers providing a driverless-printing service in proximity to a portable electronic device associated with the print job; and
for each printer from the set of printers:
attempting to obtain a protocol key and a set of supported capabilities associated with the protocol key from the printer;
if the protocol key and the set of supported capabilities exist for the printer, determining an eligibility of the printer for the print job based on the protocol key and the set of supported capabilities; and
if the printer is eligible for the print job, providing the printer to a user of the portable electronic device to enable subsequent selection of the printer for the print job.

20. The computer-readable storage medium of claim 19, the method further comprising:
if the printer is not eligible for the print job, disabling the subsequent selection of the printer for the print job.

21. The computer-readable storage medium of claim 19, wherein a discovery protocol is used to identify the set of printers providing the driverless-printing service and obtain the protocol key and the set of supported capabilities from the printer.

22. The computer-readable storage medium of claim 19, wherein determining the eligibility of the printer for the print job based on the protocol key and the set of supported capabilities involves:
comparing the supported capabilities with a set of minimum required capabilities for a protocol associated with the protocol key; and
identifying the printer as eligible for the print job if the supported capabilities meet the minimum required capabilities.

23. The computer-readable storage medium of claim 22, wherein the protocol is at least one of a raster format protocol and a page description language protocol.

24. The computer-readable storage medium of claim 19, wherein the set of supported capabilities comprises at least one of a file size and an image dimension.

25. The computer-readable storage medium of claim 19, wherein providing the printer to the user of the portable electronic device involves:
displaying the printer and other eligible printers from the set of printers to the user.
